(19) United States
(12) Patent Application Publication
(10) Pub. No.: US 2011/0297657 A1
(43) Pub. Date: Dec. 8, 2011

(54) CONTACT TIP FOR SUPPLYING WELDING ELECTRIC POWER AND WELDING TORCH USING THE CONTACT TIP

(75) Inventors: Muneharu Kutsuna, Aichi (JP); Takaaki Murakami, Shizuoka (JP)

(73) Assignee: Taiko Engineering Co., Ltd., Hamamatsu-shi, Shizuoka (JP)

(21) Appl. No.: 12/742,580

(22) PCT Filed: Feb. 4, 2010
(86) PCT No.: PCT/JP2010/000691

§ 371 Date: Aug. 18, 2011

(51) Int. Cl. B23K 9/28

(52) U.S. Cl. 219/137.44

(57) ABSTRACT

The present invention provides a welding torch which can surely fix an electric power supply point for supplying electric power to a welding wire in a wire fed-through hole, and can prevent the accumulation of dusts such as grinding dusts or the like in the wire fed-through hole thus ensuring a stable welding operation.

### TECHNICAL FIELD

The present invention relates to a contact tip for supplying electric power to a welding wire which is applicable to automatic welding, semiautomatic welding or the like in an arc welding method which uses a shielding gas such as MIG welding, MAG welding or carbon dioxide arc welding, and a welding torch which uses the contact tip for supplying welding electric power.

### BACKGROUND ART

Conventionally, robotic arc welding torch has been used in a welding operation of automobile parts or the like. A contact tip for supplying welding electric power used in such a welding torch has a function of a contact for supplying electric power to a welding wire which is a consumable electrode besides a function of a guide for guiding a wire-shaped consumable electrode to a welding position.

That is, the contact tip for supplying welding electric power is configured to straightly penetrate a wire fed-through hole which allows the feeding-through of the welding wire for welding along the axial direction of an axis portion of a body of the contact tip, and also forms a flared introduction portion on an inlet end side.

An inner diameter of the wire fed-through hole is set slightly larger than an outer diameter of a welding wire which is fed through the wire fed-through hole. While feeding the welding wire into the wire fed-through hole, electric power for welding is supplied to the welding wire from a contact portion between a contact tip for supplying welding electric power and the welding wire.

Electric power is supplied to the welding wire in a state where the welding wire is brought into contact with an inner wall surface of the wire fed-through hole. Here, since the contact tip for supplying welding electric power is made of copper alloy, due to the sliding of the welding wire at the time of feeding the welding wire, an inner wall surface of the wire fed-through hole is worn and the wear is enlarged. Accordingly, an electric power supply point from the contact tip for supplying welding electric power to the welding wire is changed momentarily so that a distance between the contact portion of the contact tip for supplying welding electric power and a member to be welded is changed whereby a voltage at an arc portion is changed so that an electric current becomes non-uniform leading to the unstable formation of a weld bead. That is, the wear of the inner wall surface of the wire fed-through hole becomes a factor which causes narrowing of a width of a weld bead or lowering of strength of a welded portion.

Further, due to the enlargement of wear of the wire fed-through hole at a distal end of the contact tip for supplying welding electric power, the positioning of the distal end of the welding wire becomes insufficient so that the distal end of the welding wire is offset from a welding point thus giving rise to a welding defect.

Still further, the enlargement of wear of the wire fed-through hole makes an electric power supply contact position remote so that an arc voltage is lowered thus generating a large quantity of sputtering. When the wear further progresses, it is no more possible to maintain an arc voltage and a welding current at fixed values so that the formation of a favorable welding bead on a member to be welded becomes impossible. Further, when the wear of the wire fed-through hole brought about by the sliding contact with the welding wire becomes remarkable, a lifetime of the contact tip for supplying welding electric power also becomes extremely short.

With respect to a technique or the like which can prevent the formation of wear of the contact tip for supplying welding electric power or the unstable supply of electric power, the following techniques have been proposed in following patent documents 1, 2, 3, for example.

Patent document 1 discloses an electrode tip for arc welding where a pair of halved tip members each of which has a groove portion extending in the longitudinal direction and has a semicircular cross section is formed by forging a rod material, and the pair of halved tip members are contacted to each other in a state where both grooves face each other in an opposed manner thus forming a true circular wire fed-through hole.

Patent document 2 discloses a contact tip for welding capable of feeding a welding wire, wherein a coating made of a heat-resistant resin is applied to an outer surface of a distal end portion of a contact tip for supplying electric power for welding.

Patent document 3 discloses a contact tip for welding where a welding wire arranged in a welding torch is pushed to an inner wall side by a leaf spring on a rear end side of a body wire fed-through hole so that the welding wire is brought into contact with an inner wall on a boundary with a distal end portion of the body wire fed-through hole.

### PRIOR ART DOCUMENT

### Patent Document

Patent document 1: JP-A-2004-306105
Patent document 2: JP-A-6-285645
Patent document 3: JP-A-2003-33877

### DISCLOSURE OF THE INVENTION

### Problems that the Invention is to Solve

However, the above-mentioned conventional techniques relating to the welding torch have, in addition to a drawback that it is difficult to stably and surely hold an electric power supply point for supplying electric power to a welding wire, oil, dusts, a drawback that worn wire dusts or the like adhered to a welding wire is collected to a proximal portion of the contact tip for supplying welding electric power when the welding wire to be supplied runs in the wire fed-through hole so that a running defect of the welding wire or a welding defect is liable to occur.

Particularly, the electrode tip for arc welding disclosed in patent document 1 is a contact tip for supplying welding electric power where the pair of halved tip members is combined so as to form a wire fed-through hole on an axis of the contact tip. Accordingly, the electrode tip for arc welding has the following drawback. That is, a hole diameter of the wire fed-through hole is uniform in the longitudinal direction so that an electric power supply point which is a portion mainly in contact with the welding wire is not surely fixed so that a distance between a portion to be welded and an electric power supply point or an electric resistance at the electric power supply point is changed whereby welding arc is liable to become unstable.

The contact tip for welding disclosed in patent document 2 which applies the heat-resistant resin coating to a distal end thereof has the following drawback. That is, although the wear resistance is temporarily decreased, the contact tip for welding has a drawback that the contact tip for welding exhibits poor durability, and a contact portion between the welding wire and the contact tip is not fixed in the same manner as the patent document 1.

The contact tip for welding disclosed in patent document 3 which forms a tapered wire fed-through hole therein has the following drawback. That is, although a position of the electric power supply point can be fixed since the leaf spring per se is held in the wire fed-through hole, the leaf spring is liable to be deteriorated so that the contact resistance is liable to be changed. Further, the structure including the leaf spring is complicate, and boring of the rod-shaped material and complicate assembling become necessary thus pushing up a cost.

The present invention has been made to overcome the above-mentioned drawbacks of the related art, and to provide a contact tip for supplying welding electric power and a welding torch which uses the contact tip for supplying welding electric power which can surely fix an electric power supply point for supplying electric power to a welding wire in a wire fed-through hole, can prevent the accumulation of dusts such as cutting dusts or oil in the wire fed-through hole, can stably perform a welding operation using the wiring wire, and is excellent in maintenance and the reduction of cost.

### Means for Solving the Problems

(1) A welding torch according to the present invention includes: a contact tip for supplying welding electric power which is constituted of a conductive member having a cylindrical portion in which a wire fed-through hole for a welding wire to be fed is formed; and a tip cover which covers the contact tip for supplying welding electric power and incorporates the contact tip for supplying welding electric power therein, wherein the contact tip for supplying welding electric power is configured such that a pair of halved tip members which has the two-split structure in the axial direction of the wire fed-through hole is combined to each other in a state where protruding portions formed on proximal ends of pressure receiving portions of the halved tip members are brought into contact with each other thus maintaining a parallel relationship between mating surfaces of the halved tip members, and the contact tip for supplying welding electric power is arranged in the inside of the tip cover in a tiltable state where a distance between distal ends of the halved tip members is expanded or shrunken, and the welding torch includes a tip-distal-end side biasing means which holds an electric power supply point for supplying electric power to the welding wire on a distal end side of the halved tip members by tilting the halved tip members so as to narrow the distance between the distal ends of the halved tip members.

(2) The welding torch according to the present invention is, in the above-mentioned constitution (1), characterized in that the tip-distal-end side biasing means includes: pressure receiving portions which are formed by extending rear end sides of the halved tip members in an approximately columnar shape having an enlarged diameter; tilting support portions which are formed on a tip pushing member which is brought into contact with corner portions of the pressure receiving portion and support the halved tip members in a tiltable state; and a resilient member which is brought into contact with back surfaces of the pressure receiving portion and pushes the pressure receiving portion thus tilting the distal ends of the halved tip members toward an axis of the wire fed-through hole formed in the contact tip for supplying welding electric power.

(3) The welding torch according to the present invention is, in the above-mentioned constitution (1) or (2), characterized in that a ceramic guide includes the wire fed-through hole which has a triangular, polygonal, cruciform or star shape and circumscribes a circular cross section of the welding wire so as to form a gap around the wire, and the ceramic guide is inserted into and arranged in a guide mounting portion formed on a distal-end-side inner wall surface of the tip cover.

(4) The welding torch according to the present invention is, in the above-mentioned constitution (3), characterized in that a discharge groove which is communicated with the gap is formed between a rear end of the ceramic guide and a distal end of the contact tip for supplying welding electric power, and a discharge hole which is communicated with the discharge groove is formed in a distal-end-side peripheral wall of the tip cover.

(5) A contact tip for supplying welding electric power according to the present invention is the contact tip for supplying welding electric power which is used in the welding torch having any one of the constitutions 1 to 4, wherein the contact tip for supplying welding electric power is configured such that a pair of halved tip members which has the two-split structure in the axial direction of the wire fed-through hole is combined to each other in a state where protruding portions formed on proximal ends of pressure receiving portions of the halved tip members are brought into contact with each other thus maintaining a parallel relationship between mating surfaces of the halved tip members, and the contact tip for supplying welding electric power is arranged in the inside of the tip cover in a tiltable state where a distance between distal ends of the halved tip members is expanded or shrunken.

(6) The contact tip for supplying welding electric power according to the present invention is, in the above-mentioned constitution (5), characterized in that the contact tip for supplying welding electric power includes: pressure receiving portions which are formed by extending rear end sides of the halved tip members while enlarging a diameter of the halved tip members in an approximately columnar shape; corner portions of the pressure receiving portion which are brought into contact with distal ends of the tilting support portions formed on the tip pushing member; and back surfaces which are brought into contact with a resilient member which tilts the distal ends of the halved tip members toward an axis of a wire fed-through hole formed in the contact tip for supplying welding electric power.

### Advantageous Effects of the Invention

According to the present invention, the contact tip for supplying welding electric power is arranged in the inside of the tip cover in a tiltable state where the distance between distal ends of the halved tip members is expanded or shrunken, and the welding torch includes a tip-distal-end side biasing means which clamps the welding wire by narrowing the distance between the distal ends of the halved tip members. Accordingly, even when the wire fed-through hole formed by the halved tip members is worn, it is possible to surely form an electric power supply point on a distal end side of the contact tip for supplying welding electric power and hence, the welding operation can be stably performed.

Further, according to the contact tip for supplying welding electric power of the present invention, the protruding portions are formed on the proximal ends of the pressure receiving portions of the halved tip members and the halved tip members are combined to each other by bringing the protruding portions into contact with each other and hence, the parallel relationship between mating surfaces of the halved tip members can be maintained at the time of feeding-through of the welding wire and, at the same time, a distance between the halved tip members on a proximal end portion side can be held at a fixed value and hence, it is possible to hold an electric power supply point at a fixed position.

### BRIEF DESCRIPTION OF THE DRAWINGS

FIG. 1 is a cross-sectional view of a welding torch according to an embodiment of the present invention.

FIG. 2 is a cross-sectional view of assembled parts of the welding torch according to the embodiment.

FIG. 3 is an explanatory view of halved tip members according to the embodiment.

FIGS. 4(a), (b) and (c) are operational explanatory views of a tip-distal-end side biasing means of the welding torch according to the embodiment, wherein (a) are a left side view, a front view and a right side view of the halved tip members, (b) is a schematic explanatory view of the tip-distal-end side biasing means, and (c) is an enlarged explanatory view of the tip-distal-end side biasing means.

FIGS. 5(a), (b) are explanatory views of a rotation prevention mechanism of the halved tip members, wherein (a) is an explanatory view of the rotation prevention mechanism of the halved tip members according to the embodiment, and (b) is an explanatory view of the rotation of conventional halved tip members.

FIG. 6 is an explanatory view of a working method of the halved tip members according to the embodiment.

FIG. 7 is an enlarged explanatory view of a ceramic guide portion in the welding torch according to the embodiment.

FIG. 8(a) is a plan view of a ceramic guide of the welding torch according to the embodiment and FIG. 8(b) is a cross-sectional view taken along a line A-A in FIG. 8(a).

FIGS. 9(a), (b) are plan views showing modifications 1,2 of the ceramic guide of the welding torch according to the embodiment.

FIG. 10 is an explanatory view showing a deviation with respect to a welding point in the contact tip for supplying welding electric power according to the embodiment.

FIG. 11 is an explanatory view of a tip wear state in the contact tip for supplying welding electric power according to the embodiment.

FIG. 12 is an explanatory view of an electric power supply point in the contact tip for supplying welding electric power according to the embodiment.

### BEST MODE FOR CARRYING OUT THE INVENTION

This embodiment is directed to a welding torch which includes:

a contact tip for supplying welding electric power which is constituted of a conductive member made of conductive metal or conductive ceramics having a cylindrical portion in which a wire fed-through hole for a welding wire to be fed is formed; and

a tip cover which covers the contact tip for supplying welding electric power and incorporates the contact tip for supplying welding electric power therein, wherein the contact tip for supplying welding electric power is configured such that a pair of halved tip members which is split in two in the axial direction of the wire fed-through hole are combined to each other in a state where protruding portions formed on proximal ends of pressure receiving portions of the halved tip members are brought into contact with each other thus maintaining a parallel relationship between mating surfaces of the halved tip members, and the contact tip for supplying welding electric power is arranged in the inside of the tip cover in a tiltable state where a distance between distal ends of the halved tip members is expanded or shrunken, and the welding torch includes a tip-distal-end side biasing means which holds an electric power supply point for supplying electric power to the welding wire on a distal end side of the halved tip members by tilting the halved tip members so as to narrow the distance between the distal ends of the halved tip members.

Due to such a constitution, it is always possible to set an electric power supply point on a side of the distal end of the contact tip for supplying welding electric power irrespective of the degree of wear of the wire fed-through hole generated by a contact between the welding wire and the wire fed-through hole. Accordingly, a stable arc phenomenon can be maintained so that productivity and operability of the welding operation can be ensured.

The welding torch of this embodiment is also a portion for holding and guiding the welding wire, and is a member applicable to automatic welding or the like in an arc welding method such as MIG welding, MAG welding or carbonic acid gas arc welding, and has a function of guiding the contact tip for supplying welding electric power from the outside such that wire feeding direction assumes the fixed direction while supplying electric power to the fed welding wire by way of the contact tip for supplying welding electric power.

The pair of halved tip members which constitutes the approximately cylindrical contact tip for supplying welding electric power are conductive members where fed-through grooves which form the wire fed-through hole are formed on inner surfaces (mating surfaces) thereof respectively, and the pair of halved tip members is brought into contact with the welding wire which runs between the fed-through grooves byway of the electric power supply point so that electric power for welding is fed to the welding wire. The halved tip members respectively have a semicircular cross section in the direction perpendicular to the axial direction of the wire fed-through hole, and the fed-through grooves having the semicircular cross section are formed at the center position of the semicircular shape.

The halved tip member is formed using a round rod (round wire) made of copper, copper alloy or the like as a material. Here, using roll working, for example, one semicircular portion of a round rod having a circular cross section is deformed into a planar surface, and the wire fed-through groove is formed in the deformed planar surface (the surface different from the other semicircular surface) in the longitudinal direction of the halved tip member.

Further, the elongated semicircular member formed by roll working is cut into members having a predetermined length by press forming or the like, and the pressure receiving portion and the protruding portion are formed on the end portion of the cut semicircular member using a mold thus forming the halved tip members.

Planar portions of the halved tip members formed in this manner are combined to each other thus forming the contact tip for supplying welding electric power where the protruding portions of the pressure receiving portions are brought into contact with each other. The contact tip for supplying welding electric power is arranged in the inside of the welding torch such that the parallel relationship between the mating surfaces of the halved tip members is maintained. Further, using the corner portions formed on the pressure receiving portions of the halved tip members as fulcrums, the contact tip for supplying welding electric power can be tilted within a minute angle so that a distance between the distal ends of the halved tip members can be expanded or shrunken.

The tip-distal-end side biasing means may be, for example, constituted by arranging a resilient member such as a tip pushing spring such that the resilient member is brought into contact with back surfaces of the halved tip members so as to push the halved tip members in the direction that the distance between both distal ends of the halved tip members is narrowed (in the direction that both distal ends approach to each other).

Further, the tip-distal-end side biasing means of the welding torch according to this embodiment may include: pressure receiving portions which are formed by extending rear end sides of the halved tip members while enlarging a diameter of the halved tip members in an approximately columnar shape; tilting support portions which are formed on a tip pushing member which is brought into contact with corner portions of the pressure receiving portion and support the halved tip members in a tiltable state; and a resilient member which is brought into contact with back surfaces of the pressure receiving portion and pushes the pressure receiving portion thus tilting the distal ends of the halved tip members toward an axis of the wire fed-through hole formed in the contact tip for supplying welding electric power.

Due to such a constitution, the biasing means can have the relatively simple constitution so that a maintenance operation such as the exchange of consumable parts can be efficiently performed.

Further, the welding torch according to this embodiment may be also characterized in that a ceramic guide includes the wire fed-through hole which has a triangular, polygonal, cruciform or star shape and circumscribes a circular cross section of the welding wire so as to form a gap around the wire, and the ceramic guide is inserted into and arranged in a guide mounting portion formed on a distal-end-side inner wall surface of the tip cover. Due to such a constitution, it is possible to discharge oil, dusts, wire grinding dusts or the like adhered to the welding wire from the gap to the outside without the retention of them in the wire fed-through hole.

The ceramic guide is an approximately frusto-conical ceramic member provided with the wire fed-through hole at a center portion thereof. The ceramic guide is inserted into a distal end side of the tip cover and is arranged on a distal end portion of the contact tip for supplying welding electric power. As ceramic for forming the ceramic guide, a ceramic material which exhibits excellent wear resistance such as alumina, alumina-silica, zirconia, silicon nitride or sialon, for example, can be used. Since the ceramic which covers the distal end portion of the contact tip for supplying welding electric power is hard, partial or non-uniform wear is little so that it is possible to feed the welding wire stably. Further, sputter hardly adheres to a surface of ceramic, and sputter can be easily removed by air or a brush even when the sputter adheres to the surface of ceramic. Further, ceramic is an insulator and hence, even when the sputter which adheres to the ceramic guide reaches the welding torch, there is no possibility of short-circuiting so that a user can safely perform a welding operation or a maintenance operation.

The wire fed-through hole formed in the ceramic guide has a cross section of a triangular shape or the like which circumscribes the welding wire having a circular cross section. Accordingly, it is possible to define the discharge gap for discharging wear dusts of wire, oil or the like around the welding wire.

The welding torch according to this embodiment may be configured such that a discharge groove which is communicated with the gap is formed between a rear end of the ceramic guide and a distal end of the contact tip for supplying welding electric power, and a discharge hole which is communicated with the discharge groove is formed in a distal-end-side peripheral wall of the tip cover. Due to such a constitution, by blowing off the wear dusts or the like pushed out from the wire fed-through hole with a high-pressure air flow, it is possible to easily remove the wear dusts or the like and hence, it is possible to provide the welding torch which exhibits the excellent maintenance property. That is, the ceramic guide is held in such a manner that three or more receiving portions are formed on a distal-end-side peripheral wall of the tip cover so as to enable the removal of the wear dusts of the welding wire or the like to the outside, and the gap is formed below the ceramic guide so as to enable the removal of the wire dusts to the outside. Further, in case where some wear dusts still remains in the wire fed-through hole in spite of the above-mentioned operations, the discharge holes are formed in three portions of the tip cover so as to blow off the wear dusts with air periodically.

Further, the contact tip for supplying welding electric power according to this embodiment is the contact tip for supplying welding electric power which is used in the above-mentioned welding torch, wherein the contact tip for supplying welding electric power is configured such that a pair of halved tip members which is formed by splitting in two in the axial direction of the wire fed-through hole is combined to each other in a state where protruding portions formed on proximal ends of pressure receiving portions of the halved tip members are brought into contact with each other thus maintaining a parallel relationship between mating surfaces of the halved tip members, and the contact tip for supplying welding electric power is arranged in the inside of the tip cover in a tiltable state where a distance between distal ends of the halved tip members is expanded or shrunken.

Further, the contact tip for supplying welding electric power according to this embodiment may include: pressure receiving portions which are formed by extending rear end sides of the halved tip members in an approximately columnar shape having an enlarged diameter; corner portions of the pressure receiving portion which are brought into contact with distal ends of the tilting support portions formed on the tip pushing member; and back surfaces which are brought into contact with a resilient member which tilts the distal ends of the halved tip members toward an axis of a wire fed-through hole formed in the contact tip for supplying welding electric power.

### Embodiment

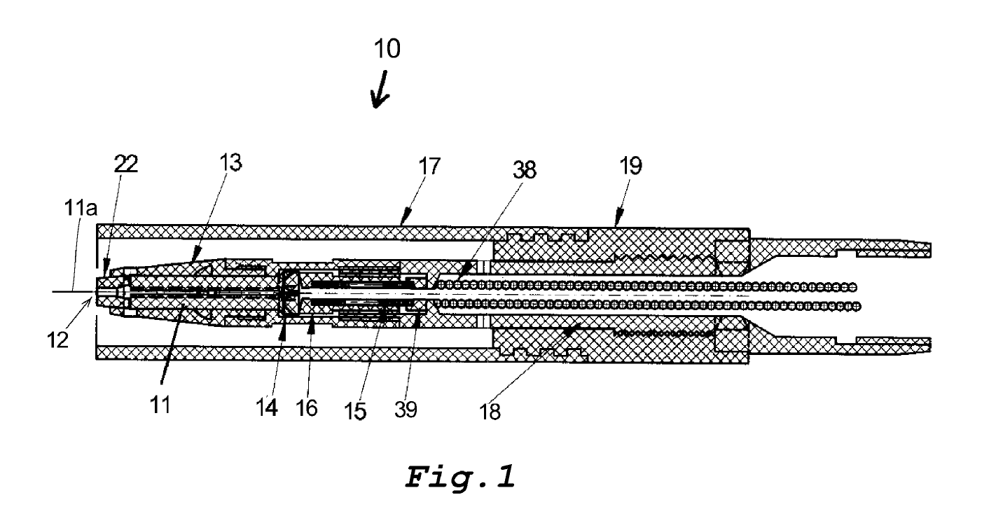

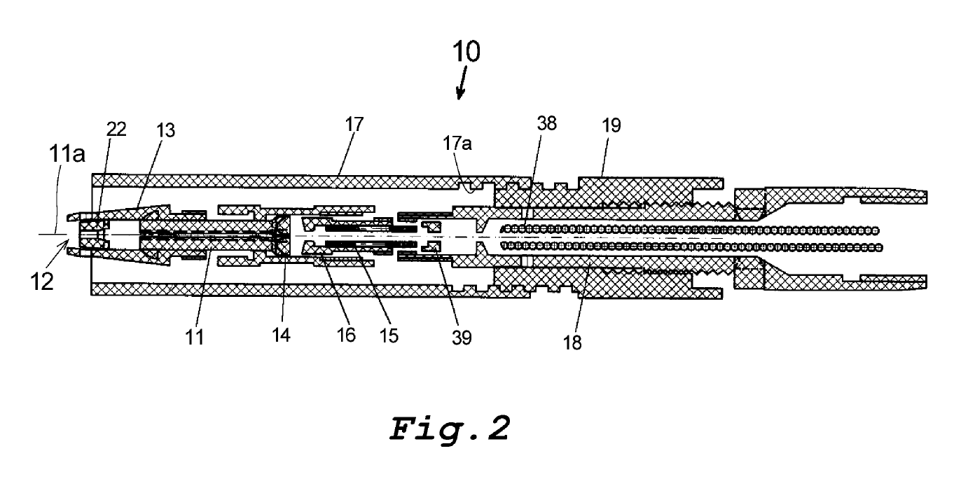

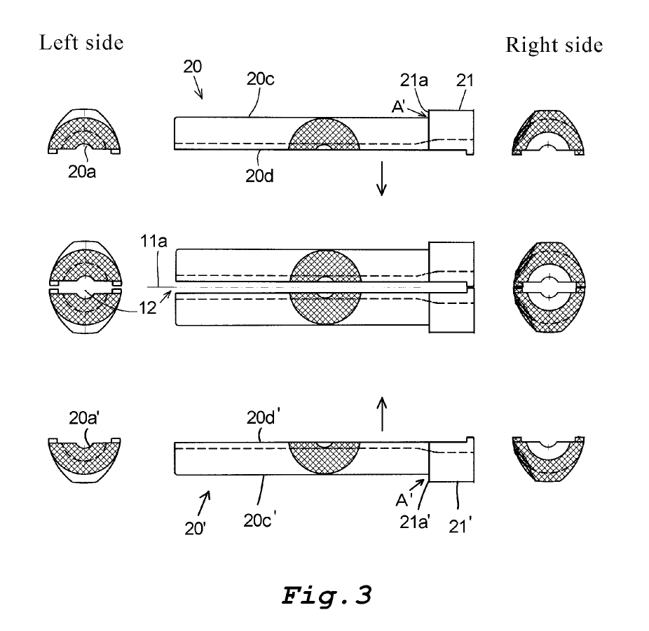

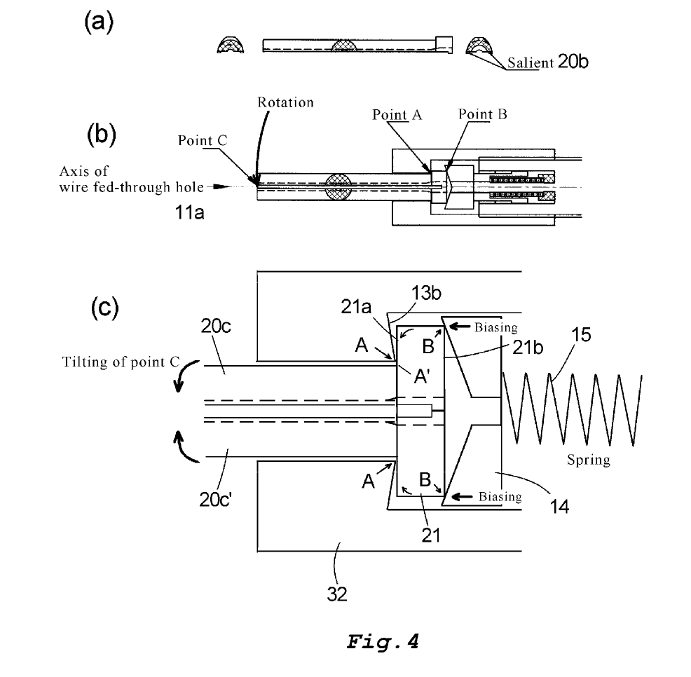

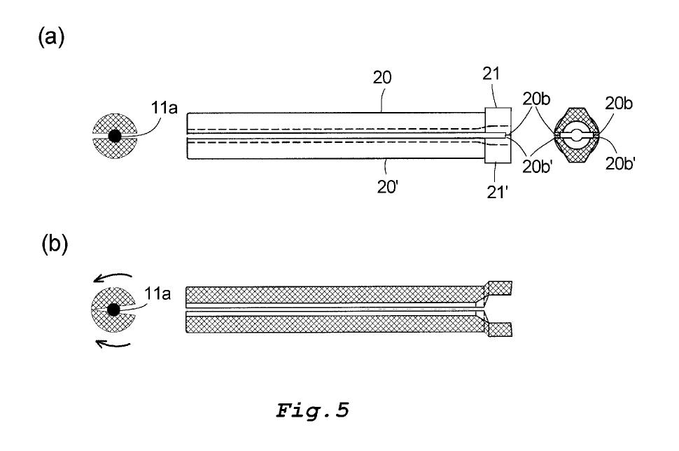

FIG. 1 is a cross-sectional view of a welding torch according to an embodiment of the present invention. FIG. 2 is a cross-sectional view of assembled parts of the welding torch according to the embodiment. FIG. 3 is an explanatory view of halved tip members according to the embodiment. FIG. 4 is a series of explanatory operation views of a tip-distal-end side biasing means of the welding torch according to the embodiment, wherein (a) are a left side view, a front view and a right side view of the halved tip members, (b) is a schematic explanatory view of the tip-distal-end side biasing means, and (c) is an enlarged explanatory view of the tip-distal-end side biasing means. FIG. 5 is explanatory views of a rotation prevention mechanism of the halved tip members, wherein (a) is an explanatory view of the rotation prevention mechanism of the halved tip members according to the embodiment, and (b) is an explanatory view of the rotation of conventional halved tip members.

The welding torch 10 of this embodiment includes, as shown in FIG. 1 and FIG. 2, a contact tip 11 for supplying welding electric power which is formed by combining a pair of halved tip members 20, 20′ made of conductive metal into an approximately cylindrical shape, a tip cover 13 which holds the contact tip 11 for supplying welding electric power, a tip receiving base 16 which supports a proximal end side of the tip cover 13 by way of a tip pushing member 14, an insulation bush 19 which pivotally supports the tip receiving base 16 by way of a nozzle adapter 34, and a wire fed-through hole 12 which is formed in the contact tip 11 for supplying welding electric power in a penetrating manner along an axis of the contact tip 11 for supplying welding electric power and allows the feeding-through of the welding wire supplied from the proximal end side.

An insulation bushing 19 is formed of a synthetic resin mold having high heat resistance and high insulation property or the like, and a torch nozzle 17 which covers the tip cover 13 in a cylindrical shape is mounted on a front side of the insulation bushing 19 by way of a threaded portion 17a. A tip pushing spring (resilient member) 15 made of stainless steel, spring steel or ceramic and a wire guide 38 are incorporated into the tip receiving base 16 and a torch adapter 18. These elements are arranged to function as a tip distal end side biasing means for clamping a distal end side of the contact tip 11 for supplying welding electric power by biasing an axially proximal end side of the contact tip 11 for supplying welding electric power by way of the tip receiving base 16 and the tip pushing member 14.

Here, between the tip pushing spring 15 and the tip adapter 18, an insulation washer 39 made of cloth-containing bakelite or the like is arranged so as to prevent an electric current from flowing into the tip pushing spring 15.

Further, as shown in FIG. 1 and FIG. 2, the tip cover 13 is fixed to the torch nozzle 17 by way of the insulation bushing 19. Here, arc welding can be performed by supplying a shield gas to a space defined between an outer wall portion of the tip cover 13 and an inner wall portion of the torch nozzle 17.

The contact tip 11 for supplying welding electric power is constituted, as shown in FIG. 3 and FIG. 4, by combining a pair of halved tip members 20, 20′ which are formed in a two-split manner along the axis 11a direction of the wire fed-through hole 12 such that planer mating surfaces 20d, 20d′ of the halved tip members 20, 20′ face each other in an opposed manner. On these mating surfaces 20d, 20d′, fed-through grooves 20a, 20a′ which form the wire fed-through hole 12 when combined are formed in the longitudinal direction respectively.

Each halved tip member 20, 20′ is constituted of a two-split cylindrical portion 20c, 20c′ which ifs formed by splitting the cylindrical portion in two in the axis 11a direction and a pressure receiving portion 21, 21′ which is formed by extending a rear end side of the two-split cylindrical portion 20c, 20c′ while enlarging a diameter thereof in an approximately cylindrical shape. Corner portions A′ are formed on boundaries between outer surfaces of the two-split cylindrical portions 20c and raised portions 21a, 21a′ of the pressure receiving portions 21 which extend from the outer surfaces of the two-split cylindrical portions 20c while enlarging a diameter of the extending portions.

As a material used for forming the halved tip members 20, 20′, besides metal and alloy having conductive alloy such as copper-chromium alloy, brass, pure copper, copper-zirconium alloy, brass, aluminum bronze or phosphor bronze, for example, a conductive material such as conductive ceramic may be used.

The wire fed-through hole 12 formed in the contact tip 11 for supplying welding electric power which is formed by the combination of the fed-through grooves 20a, 20a′ has a circular cross section, and a diameter of the wire fed-through hole 12 approximately conforms to a diameter of the welding wire W.

Next, the manner of operation of the tip distal end side biasing means is further explained in detail in conjunction with FIG. 4. Here, the explanation is made using one halved tip member.

The halved tip member 20 is provided with the pressure receiving portion 21 which is formed by extending a proximal end side of the halved tip member 20 in an approximately columnar shape having an enlarged diameter. A corner portion (point A′) of a front end portion 21a (on a distal end portion direction side of the halved tip member) is brought into contact with a distal end (minimum diameter portion: point A) of a tilting support portion 13b which is formed on an inner wall surface of one end portion of the approximately cylindrical tip pushing member 13 with a cross section having a hook shape where the inner wall surface projects inwardly and away from the end portion (in the right direction in the drawing).

That is, the tilting support portion 13b has a surface thereof inclined such that the tilting support portion 13b is brought into contact with the minimum diameter portion A by preventing the interference of tilting support portion 13b with the front end surface 21a of the pressure receiving portion 21 of the halved tip member 20 even when the halved tip member 20 is biased and tilted due to the tip pushing spring 15.

Then, the front surface of the tip pushing member 14 which is biased by the tip pushing spring 15 from behind is brought into contact with an outermost diameter edge portion (point B) of the rear end surface 21b of the pressure receiving portion 21 of the halved tip member 20 so that the distal end portion (point C) of the groove forming portion 20c of the halved tip member 20 is tilted in the axis 11a direction of the wire fed-through hole 12 formed in the contact tip 11 for supplying welding electric power.

In this manner, it is possible to provide the tip distal end side biasing means as a mechanism in which, by using the point B on the pressure receiving portion 21 of the halved tip member 20 as a point of force and the point A of the tilting support portion 13b as a fulcrum, the distal end portion (point C) of the halved tip member 20 is tilted in the axis 11a direction of the wire fed-through hole 12.

Here, although the manner of operation is explained with respect to one halved tip member, the other halved tip member is operated in the same manner.

Here, as shown in FIG. 5(a), by forming protruding portions 20b, 20b′ on the pressure receiving portion 21, 21′ of the halved tip members, and by combining the halved tip members 20, 20′ together by bringing the protruding portions 20b, 20b′ into contact with each other, it is possible to maintain a distance for forming the wire fed-through hole 12 at a fixed value on a proximal end portion side (pressure receiving portion side) and, at the same time, when the welding wire W is fed through the wire fed-through hole 12, it is possible to prevent a phenomenon that one of the halved tip members 20, 20′ is rotated about the axis 11a of the wire fed-through hole 12 so that a distance between the mating surfaces of the halved tip members is narrowed.

That is, with respect to the halved tip members of this embodiment, the distance between the halved tip members is set to a fixed value on the proximal end portion side (pressure receiving portion side), and the distance between the distal ends of the halved tip members 20, 20′ can be decreased (the distal ends of the halved tip members 20, 20′approach to each other) by merely tilting the halved tip members only on the C point side.

Further, as shown in a left side view in FIG. 5(a), the contact tip 11 for supplying welding electric power is constituted by bringing the protruding portions 20b, 20b′ formed on both radial-directional edges of lower surfaces of the proximal ends of the pressure receiving portions 21, 21′ into contact with each other and hence, the rotation of the halved tip members 20, 20′ about the axis 11a can be prevented so that the mating surfaces of the halved tip members 20, 20′ can be held parallel to each other whereby it is possible to stably hold a position of an electric power supply point of the contact tip 11 for supplying welding electric power. When it comes to a conventional contact tip for supplying welding electric power shown in FIG. 5(b), halved tip members are not provided with protruding portions and hence, one of the halved tip members is rotated and is deviated (one edges of the halved tip members are brought into contact with each other) whereby arc cannot be generated stably.

The protruding portions 20b formed on the proximal end of the pressure receiving portion 21 are formed by bulging portions of a plane constituting a rear end surface 21b of the pressure receiving portion 21 downwardly and by extending the portions in both radially outward directions from the axis 11a of the wire fed-through hole 12. The protruding portions 20b′ are also formed in the same manner.

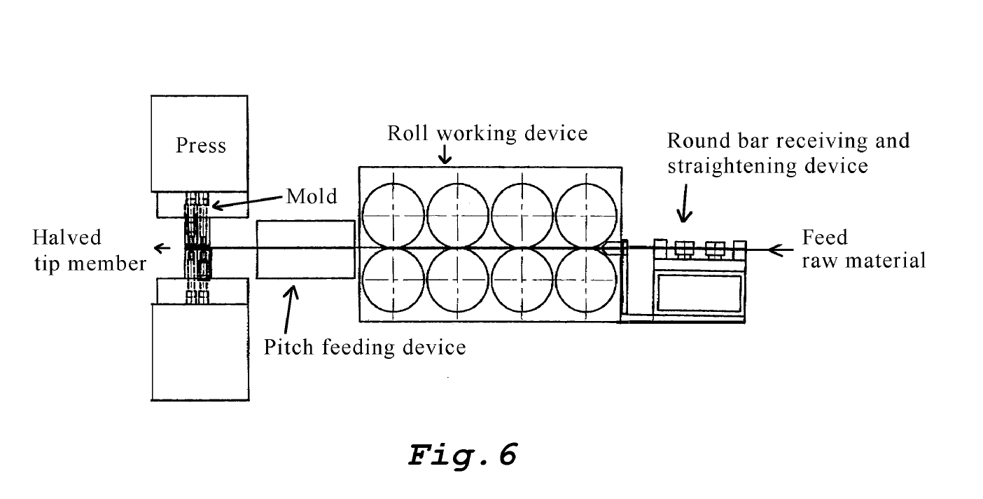

The halved tip members 20, 20′ which constitute the contact tip 11 for supplying welding electric power can be manufactured by a manufacturing method shown in FIG. 6, for example. That is, bending of a round rod (a round wire) which is used as a material is straightened by a rod receiving device, and using a roll forming device or the like, one circular curved surface of the round rod having a circular cross section is deformed into a planar surface by roll working, and the wire fed-through groove is formed at the center in the longitudinal direction on the planar surface formed by deformation (different from the other cylindrical surface). Then, after being subject to such working, the round rod is conveyed to a press using a pitch feeding device, and the pressure receiving portion 21, the protruding portions 20b and the like are formed using a press mold and, thereafter, the round rod is cut to manufacture the halved tip members 20.

When the wire fed-through groove is formed by roll working, it is possible to easily form the wire fed-through groove different from the formation of the wire fed-through groove using a drill or the like and, at the same time, it is possible to form the smooth wire fed-through hole 12 having increased surface hardness by work hardening whereby the contact tip 11 for supplying welding electric power can possess high quality as a welding torch.

In this manner, by biasing the tip pushing member 14 with the tip pushing spring 15, the distance between the distal ends of the halved tip members 20, 20′ is narrowed so that a distal end side (in the vicinity of the point C) of the welding wire W interposed between the distal ends of the halved tip members 20, 20′ is pushed at a fixed pressure whereby it is possible to stably form an electric power supply point for supplying electric power to the welding wire Won a nozzle distal end side.

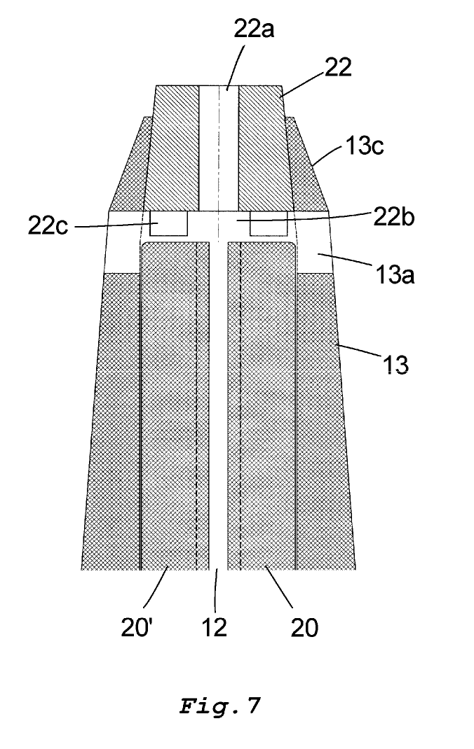

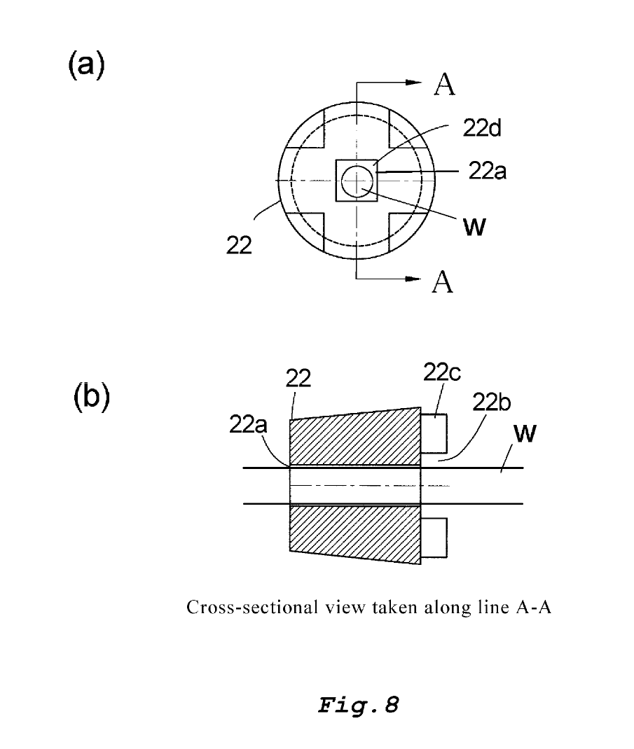

Next, the ceramic guide which is mounted on the tip cover of the welding torch is explained. FIG. 7 is an enlarged explanatory view of the ceramic guide which is mounted on the tip cover of the welding torch according to the embodiment, and FIG. 8 is a set of views constituted of a plan view (a) and a cross-sectional view (b) of the ceramic guide taken along a line A-A.

In the welding torch 10 of the embodiment, the ceramic guide 22 formed in an approximately frusto-conical shape is mounted on the frontwardly tapered guide mounting portion 13c formed on a distal-end-side inner wall surface of the frontwardly tapered tip cover 13 such that the ceramic guide 22 is fitted into the guide mounting portion 13c from the inside whereby the ceramic guide 22 is arranged on a distal end side of the contact tip 11 for supplying welding electric power.

The ceramic guide 22 is made of a ceramic material such as alumina, zirconia, silicon nitride or the like, for example, and a wire fed-through hole 22a having a square cross section is formed in the ceramic guide 22 along an axis of the ceramic guide 22. Further, on a rear end portion of the ceramic guide 22 with which the distal end of the contact tip 11 for supplying welding electric power is brought into contact, bridge portions 22c which form discharge grooves 22b are formed between the ceramic guide 22 and the contact tip 11 for supplying welding electric power.

Further, as shown in FIG. 6, the wire fed-through hole 22a formed in the ceramic guide 22 is communicated with the discharge grooves 22b on a proximal end side thereof. Still further, discharge holes 13a which are communicated with the discharge grooves 22b formed in the ceramic guide 22 are formed in a distal end side peripheral wall of the tip cover 13. For example, the discharge holes 13a are arranged at positions which divide the circumference of a peripheral wall of the holder in three or four respectively.

As shown in FIG. 8, when the welding wire having a circular cross section is fed through the wire fed-through hole 22a having a square cross section, gaps 22d are formed at square corner portions in the cross section of the wire fed-through hole 22a due to the difference in shape between the welding wire W and the wire fed-through hole 22a. Accordingly, it is possible to effectively discharge wire debris, oil dusts or the like generated due to a friction between the wire fed-through hole and the welding wire through the gaps 22d, the discharge grooves 22b and the discharge holes 13a.

Further, dusts which are not discharged and stay in the wire fed-through hole 22a can be removed by blowing off air from peripheries of the discharge holes 13a.

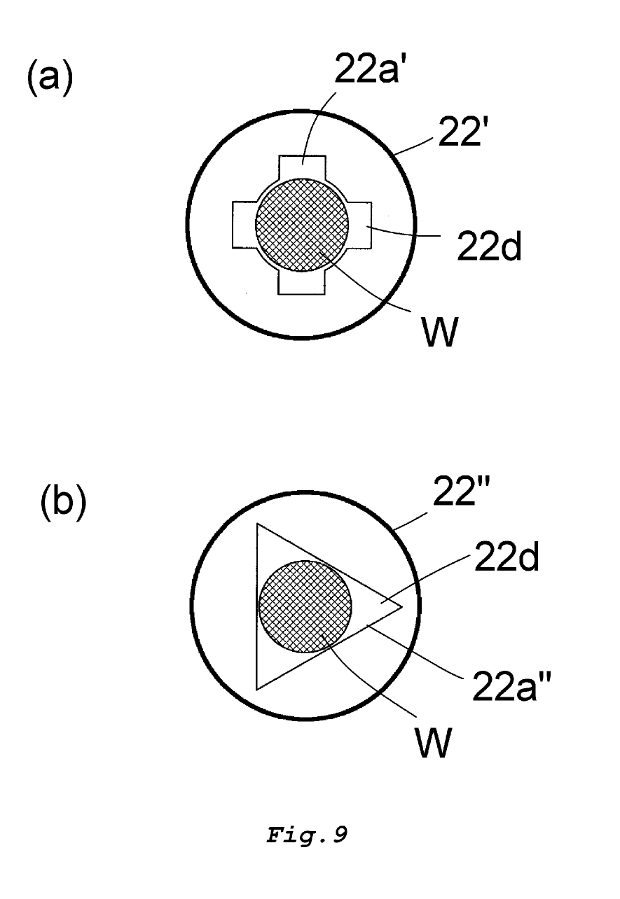

FIGS. 9(a) (b) are cross-sectional views showing the ceramic guides according to modifications 1, 2. As shown in FIG. 9(a), in the ceramic guide 22′ according to the modification 1, the wire fed-through hole 22a′ has a cruciform cross section, while as shown in FIG. 9(b), in the ceramic guide 22″ according to the modification 2, the wire fed-through hole 22a″ has a triangular cross section.

In this manner, by forming the gaps 22d for discharging wire dusts, oil or the like to the periphery of the welding wire W having the circular cross section in conformity with a use environmental condition thus promoting the discharge of the wire dusts or the like, it is possible to provide the welding torch 10 which exhibits the excellent welding arc stability and the excellent maintenance property.

Here, with respect to the contact tip 11 for supplying welding electric power of the welding torch 10 of this embodiment, different from a conventional contact tip for supplying welding electric power to which profile forming, boring and threads forming are applied using a lathe, as shown in FIG. 6, it is possible to form the pair of halved tip members 20, 20′ to be combined at a high speed by simultaneously cutting the semicircular materials formed by the roll forming machine R by press forming.

Accordingly, the contact tip for supplying welding electric power can be manufactured extremely efficiently at a low cost.

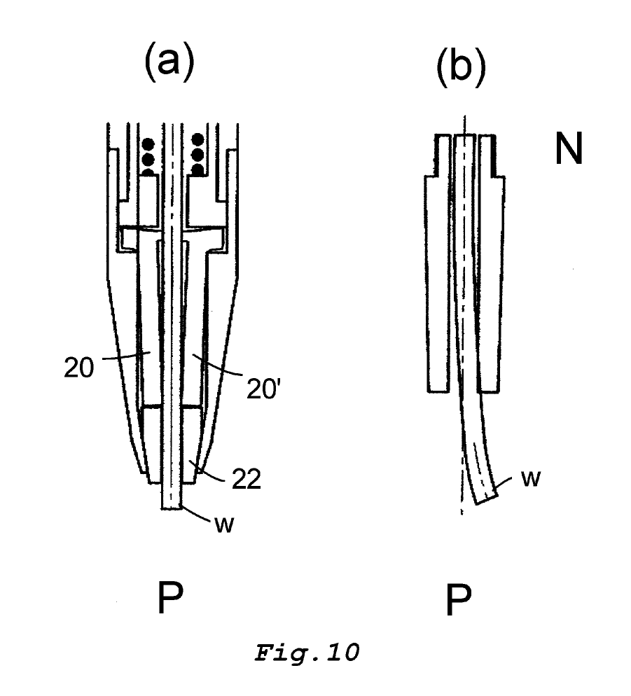

In the welding torch 10 according to this embodiment, the ceramic guide 22 is formed as shown in FIG. 10(a) and hence, different from a conventional welding torch N shown in FIG. 10(b), there is no possibility that the wear progresses rapidly so that aiming of a welding target position P is deviated. Aiming of the welding target position can be limited to a narrow range.

The welding torch of this embodiment can perform the accurate welding operation in this manner and hence, it is possible to bring about the enhancement of the welding quality and the enhancement of the productivity.

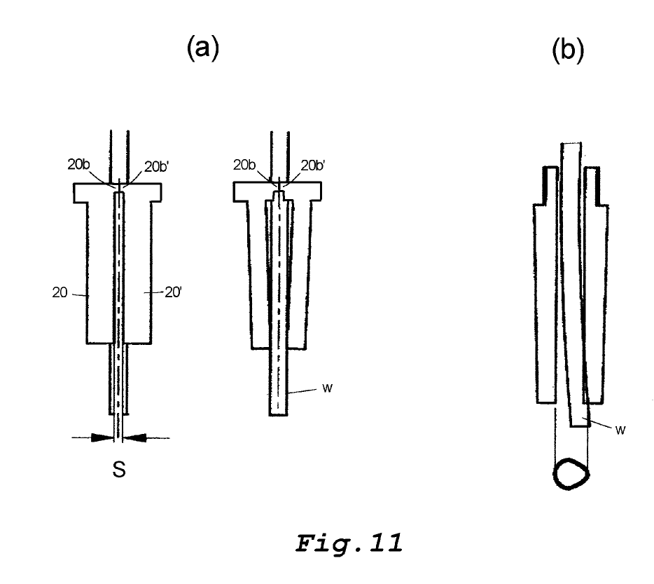

Further, as shown in FIG. 11, according to the contact tip 11 for supplying welding electric power of this embodiment, in forming the contact tip 11 for supplying welding electric power by combining the halved tip members 20, 20′, as shown in FIG. 11(a), the protruding portions 20b of the pressure receiving portions 21 are brought into contact with each other thus forming a gap S which is a wear margin between parallel surfaces of the halved tip members 20, 20′. Accordingly, even when the wear of the fed-through grooves 20a, 20a′ progresses, it is possible to use the welding torch until the gap between the parallel surfaces of the halved tip members 20, 20′ does not exist and hence, the lifetime of the welding torch can be prolonged.

To the contrary, when the halved tip members 20, 20′ provided with no protruding portions 20b are combined so as to form the contact tip 11 for supplying welding electric power so that no gap S which is a wear margin is formed between the parallel surfaces of the halved tip members 20, 20′, the welding wire W which has bending property is supplied so that a distal end side of the contact tip for supplying welding electric power is worn in an elliptical shape at an early stage so that the lifetime of the welding torch becomes short.

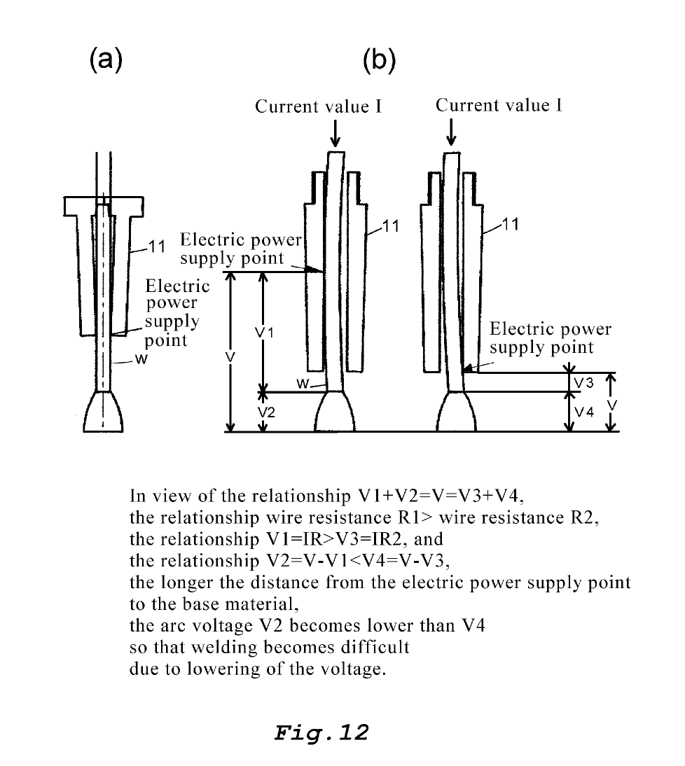

Further, in the welding tip which uses the conventional contact tip T for supplying welding electric power, as shown in FIG. 12(b), a contact position between the welding wire W and the contact tip T for supplying welding electric power (distance between the tip electric power supply point and a base material) in the wire fed-through hole is changed due to bending property of the welding wire W thus giving rise to a case where an arc voltage is changed so that the accurate welding becomes difficult.

To the contrary, in this embodiment, as shown in FIG. 12(a), the points B at the proximal ends of the halved tip members 20, 20′ are axially pushed by way of the tip distal end side biasing means and hence, using the point A as a fulcrum, the welding wire W is forcibly rotated and clamped on the side of the distal end of the contact tip for supplying welding electric power whereby the electric power supply point is fixed to the point C at the distal end of the contact tip for supplying welding electric power and is not changed.

Accordingly, the welding wire W can be fed stably, and the contact tip supply voltage can be held at a fixed value thus giving rise to an advantageous effect that the welding torch can ensure favorable and proper welding conditions.

Further, the contact portion between the contact tip for supplying welding electric power and the welding wire W is pushed with a fixed pushing force due to a force of the spring (supply of electric power under a resilient force) and hence, a fixed electric current flows so that welding penetration and the generation of arc become stable.

### INDUSTRIAL APPLICABILITY

The contact tip for supplying welding electric power and the welding torch which uses the contact tip according to the present invention are broadly applicable to methods such as an arc welding method which welds metal such as aluminum, copper, copper alloy, heat resistance steel or titanium alloy.

For example, the contact tip for supplying welding electric power or the welding torch is mounted on an arc welding machine provided with a robot arm, and is applicable to, besides automatic welding which requires an accurate manipulation, semiautomatic welding which welds an object to be welded by manipulating the welding torch while observing a portion to be welded.

Further, electric power can be supplied while applying a pushing force to a distal end portion of the contact tip for supplying welding electric power and hence, it is possible to perform welding at a high speed with stable arc generation whereby the welding operability and welding quality are enhanced and a welding cost can be pushed down.

Still further, even when the contact tip for supplying welding electric power is worn or wear dusts is adhered to the wire fed-through hole, the wear dusts can be easily discharged by way of the discharge grooves formed in the ceramic guide and the discharge holes formed in the insulation nozzle and hence, the feeding direction of the welding wire is hardly changed so that there is no positional displacement of the welding portion thus enhancing the operability of the welding torch.

### EXPLANATION OF SYMBOLS

10: welding torch of embodiment
11: contact tip for supplying welding electric power
11a: axis of wire fed-through hole
12: wire fed-through hole
13: tip cover
13a: discharge hole
13b: tilting support portion
13c: guide mounting portion
14: tip pushing member
15: tip pushing spring (resilient member)
16: tip receiving base
17: torch nozzle
17a: threaded mounting portion
18: torch adapter
19: insulation bushing
20, 20′: halved tip member
20a, 20a′: fed-through groove
20b, 20b′: protruding portion
20d, 20d′: mating surface
21, 21′: pressure receiving portion
22, 22′, 22″: ceramic guide
22a, 22a′, 22a″: wire fed-through hole
22b: discharge groove
22c: bridge portion
22d: gap
38: wire guide
39: insulation washer

1. A welding torch comprising:
a contact tip for supplying welding electric power which is constituted of a conductive member having a cylindrical portion in which a wire fed-through hole for a welding wire to be fed is formed; and
a tip cover which covers the contact tip for supplying welding electric power and incorporates the contact tip for supplying welding electric power therein, wherein
the contact tip for supplying welding electric power is configured such that
a pair of halved tip members which has the two-split structure in the axial direction of the wire fed-through hole is combined to each other in a state where protruding portions formed on proximal ends of pressure receiving portions of the halved tip members are brought into contact with each other thus maintaining a parallel relationship between mating surfaces of the halved tip members, and the contact tip for supplying welding electric power is arranged in the inside of the tip cover in a tiltable state where a distance between distal ends of the halved tip members is expanded or shrunken, and
the welding torch includes a tip-distal-end side biasing means which holds an electric power supply point for supplying electric power to the welding wire on a distal end side of the halved tip members by tilting the halved tip members so as to narrow the distance between the distal ends of the halved tip members.

2. The welding torch according to claim 1, wherein the tip-distal-end side biasing means includes:
pressure receiving portions which are formed by extending rear end sides of the halved tip members in an approximately columnar shape having an enlarged diameter;
tilting support portions which are formed on a tip pushing member which is brought into contact with corner portions of the pressure receiving portion and support the halved tip members in a tiltable state; and
a resilient member which is brought into contact with back surfaces of the pressure receiving portion and pushes the pressure receiving portion thus tilting the distal ends of the halved tip members toward an axis of the wire fed-through hole formed in the contact tip for supplying welding electric power.

3. The welding torch according to claim 1, wherein a ceramic guide includes the wire fed-through hole which has a triangular, polygonal, cruciform or star shape and circumscribes a circular cross section of the welding wire so as to form a gap around the wire, and the ceramic guide is inserted into and arranged in a guide mounting portion formed on a distal-end-side inner wall surface of the tip cover.

4. The welding torch according to claim 3, wherein a discharge groove which is communicated with the gap is formed between a rear end of the ceramic guide and a distal end of the contact tip for supplying welding electric power, and a discharge hole which is communicated with the discharge groove is formed in a distal-end-side peripheral wall of the tip cover.

5. A contact tip for supplying welding electric power which is used in the welding torch according to claim 1, wherein the contact tip for supplying welding electric power is configured such that
a pair of halved tip members which has the two-split structure in the axial direction of the wire fed-through hole is combined to each other in a state where protruding portions formed on proximal end portions of pressure receiving portions of the halved tip members are brought into contact with each other thus maintaining a parallel relationship between mating surfaces of the halved tip members, and the contact tip for supplying welding electric power is arranged in the inside of the tip cover in a tiltable state where a distance between distal ends of the halved tip members is expanded or shrunken.

6. The contact tip for supplying welding electric power according to claim 5, wherein the contact tip for supplying welding electric power includes:
pressure receiving portions which are formed by extending rear end sides of the halved tip members in an approximately columnar shape having an enlarged diameter;
corner portions of the pressure receiving portion which are brought into contact with distal ends of the tilting support portions formed on the tip pushing member; and
back surfaces which are brought into contact with a resilient member which tilts the distal ends of the halved tip members toward an axis of a wire fed-through hole formed in the contact tip for supplying welding electric power.
